(19) United States
(12) Patent Application Publication
(10) Pub. No.: US 2014/0009944 A1
(43) Pub. Date: Jan. 9, 2014

(54) LIGHT FLUX CONTROLLING MEMBER, LIGHT EMITTING APPARATUS, SURFACE LIGHT SOURCE APPARATUS, AND DISPLAY APPARATUS

(71) Applicant: ENPLAS CORPORATION, Saitama (JP)

(72) Inventor: Yasuyuki FUKUDA, Saitama (JP)

(21) Appl. No.: 13/934,319

(22) Filed: Jul. 3, 2013

(30) Foreign Application Priority Data
Jul. 4, 2012 (JP) 2012-150456

(51) Int. Cl. F21V 5/04

(52) U.S. Cl. CPC F21V 5/046
USPC 362/311.08; 362/326; 362/311.09

(57) ABSTRACT

Light flux controlling member (100) includes emission surface (110) that includes emission concave portion (111) formed so as to intersect with optical axis (LA) of light emitting element (210), incidence surface (120) that constitutes an inner surface of incidence concave portion (121) formed on the opposite side of emission concave portion (111), and back surface (130) that extends in a direction perpendicular to optical axis (LA) from an opening edge portion of incidence concave portion (121). A cross section of at least one of emission surface (110) and incidence surface (120) which is perpendicular to optical axis (LA) has an elliptical shape.

### CROSS REFERENCE TO RELATED APPLICATIONS

This application is entitled and claims the benefit of Japanese Patent Application No. 2012-150456, filed on Jul. 4, 2012, the disclosure of which including the specification, drawings and abstract is incorporated herein by reference in its entirety.

### TECHNICAL FIELD

The present invention relates to a light flux controlling member that controls light distribution of light emitted from a light emitting element. Further, the present invention relates to a light emitting apparatus including the light flux controlling member, a surface light source apparatus including the light emitting apparatus, and a display apparatus including the surface light source apparatus.

### BACKGROUND ART

Some transmission type image display apparatuses including liquid crystal display apparatuses use direct-type surface light source apparatuses as a backlight, In recent years, direct-type surface light source apparatuses having a plurality of light emitting elements as a light source have come into use.

For example, a direct-type surface light source apparatus includes a substrate, a plurality of light emitting elements, a plurality of light flux controlling members (lens), and a light diffusion member. The plurality of light emitting elements are arranged in a matrix shape on the substrate. Above each light emitting element, the light flux controlling member that expands the light emitted from each light emitting element in a surface direction of the substrate is arranged. The light emitted from the light flux controlling member is diffused by the light diffusion member, and illuminates an illumination target member (for example, a liquid crystal panel) in a planar shape.

On the other hand, Patent Literature 1 discloses a light flux controlling member that controls light distribution of light emitted from a light emitting element, in which the light flux controlling member can control light distribution individually in two directions perpendicular to an optical axis of the light emitting element and perpendicular to each other. FIG. 1 is a diagram showing a configuration of light emitting apparatus 10 including light emitting element 20 and light flux controlling member (lens) 30 that is disclosed in Patent Literature 1. FIG. 1A is a plan view of light emitting apparatus 10, FIG. 1B is a cross-sectional view taken along line A-A shown in FIG. 1A, and FIG. 1C is a cross-sectional view taken along line B-B shown in FIG. 1A. In these drawings, it is assumed that a direction of optical axis CA of the light emitting element is a z-axis direction. In addition, it is assumed that two directions perpendicular to a z-axis and perpendicular to each other are an x-axis direction and a y-axis direction.

As shown in FIG. 1A, light flux controlling member 30 includes two convex curved surfaces 32 and fillet portion 34 that is interposed between two convex curved surfaces 32. Two convex curved surfaces 32 and fillet portion 34 are curved so as to be continuous with each other. As shown in FIG. 1C, in a cross section of light flux controlling member 30 which is parallel to an xz plane, fillet portion 34 has a concave shape. For this reason, light flux controlling member 30 can expand light emitted from light emitting element 20 in the x-axis direction. On the other hand, as shown in FIG. 1B, in a cross section of light flux controlling member 30 which is parallel to a yz plane, the entirety has a convex shape. For this reason, light flux controlling member 30 concentrates the light emitted from light emitting element 20 on optical axis LA side in the y-axis direction. In this manner, light flux controlling member 30 disclosed in Patent Literature 1 can control light distribution individually in the x-axis direction and the y-axis direction.

### CITATION LIST

### Patent Literature

### PTL 1

Japanese Patent Application Laid-Open No. 2011-040315

### SUMMARY OF INVENTION

### Technical Problem

As described above, light flux controlling member 30 disclosed in Patent Literature 1 expands the light emitted from light emitting element 20 in the x-axis direction, but concentrates the light in the y-axis direction. Therefore, when light flux controlling member 30 disclosed in Patent Literature 1 is applied to a direct-type surface light source apparatus, there is a problem in that it is not possible to uniformly irradiate the light diffusion member with light, and thus a bright portion is likely to be generated.

An object of the present invention is to provide a light flux controlling member that controls light distribution of light emitted from a light emitting element, in which the light flux controlling member can control the light distribution individually in two directions perpendicular to an optical axis of the light emitting element and perpendicular to each other, and can suppress the occurence of illuminance unevenness.

In addition, another object of the present invention is to provide a light emitting apparatus including the light flux controlling member, a surface light source apparatus including the light emitting apparatus, and a display apparatus including the surface light source apparatus.

### Solution to Problem

In order to achieve the above-mentioned objectives, provided is a light flux controlling member for controlling a light distribution of light emitted from a light emitting element. The light flux controlling member includes an emission surface that includes an emission concave portion formed so as to intersect with an optical axis of the light emitting element; an incidence surface that constitutes an inner surface of an incidence concave portion formed on the opposite side of the emission concave portion; and a back surface that extends in a direction perpendicular to the optical axis from an opening edge portion of the incidence concave portion. At least one of the emission surface and the incidence surface has an elliptical shape in cross section, the cross section being perpendicular to the optical axis.

A light emitting apparatus of the present invention includes the light emitting element, and the light flux controlling member of the present invention.

A surface light source apparatus of the present invention includes the light emitting apparatus of the present invention, and a light diffusion member for transmitting light emitted from the light emitting apparatus while diffusing the light.

A display apparatus of the present invention includes the surface light source apparatus of the present invention, and a display member to be irradiated with light emitted from the surface light source apparatus.

### Advantageous Effects of Invention

The light flux controlling member of the present invention can control light distribution individually in two directions that are perpendicular to the optical axis of the light emitting element and are perpendicular to each other. The light emitting apparatus including the light flux controlling member of the present invention can uniformly radiate light, as compared with the light emitting apparatus of the related art. Therefore, the surface light source apparatus and the display apparatus of the present invention have a little brightness unevenness as compared with the apparatus of the related art.

### BRIEF DESCRIPTION OF DRAWINGS

FIGS. 1A to 1C are diagrams showing a configuration of a light emitting apparatus of the related art disclosed in Patent Literature 1;

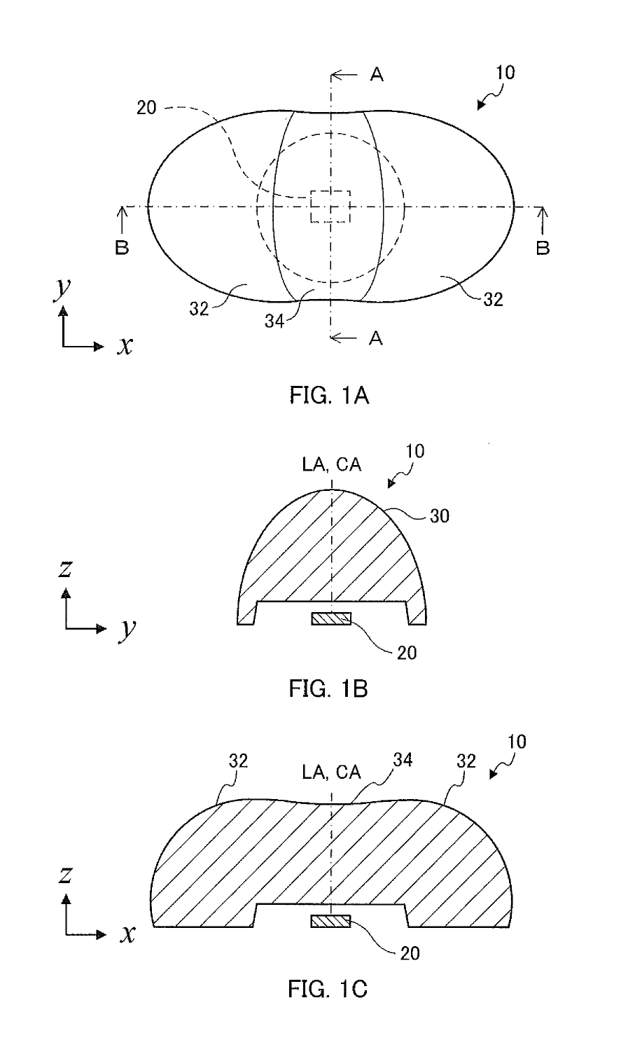

FIGS. 2A and 2B are diagrams showing configurations of a surface light source apparatus and a light emitting apparatus according to Embodiment 1;

FIGS. 3A to 3C are diagrams showing a configuration of a light flux controlling member according to Embodiment 1;

FIGS. 4A to 4C are diagrams showing a configuration of the light flux controlling member according to Embodiment 1;

FIG. 5 is a bottom view of a light flux controlling member according to a modified example of Embodiment 1;

FIGS. 6A and 6B are bottom views of a light flux controlling member according to a modified example of Embodiment 1;

FIGS. 7A to 7C are diagrams showing a configuration of a light flux controlling member according to Embodiment 2;

FIGS. 8A and 8B are diagrams showing a configuration of the light flux controlling member according to Embodiment 2;

FIG. 9 is a bottom view of a light flux controlling member according to a modified example of Embodiment 2;

FIG. 10 is a diagram illustrating simulation conditions;

FIGS. 11A to 11E are schematic plan views of light flux controlling members used for the simulation;

FIG. 12 is a graph showing simulation results when θ=15°;

FIG. 13 is a graph showing simulation results when θ=30°;

FIG. 14 is a graph showing simulation results when θ=45°; and

FIG. 15 is a graph showing simulation results when θ=60°.

### DESCRIPTION OF EMBODIMENTS

Now, embodiments of the present invention will be described in detail with reference to the accompanying drawings. In the following explanations, as representative examples of the surface light source apparatus of the present invention, surface light source apparatuses suitable for, for example, a backlight of a liquid crystal display apparatus will be explained. These surface light source apparatuses can be used as a display apparatus in combination with a display member such as a liquid crystal panel.

### Embodiment 1

Configuration of Surface Light Source Apparatus and Light Emitting Apparatus

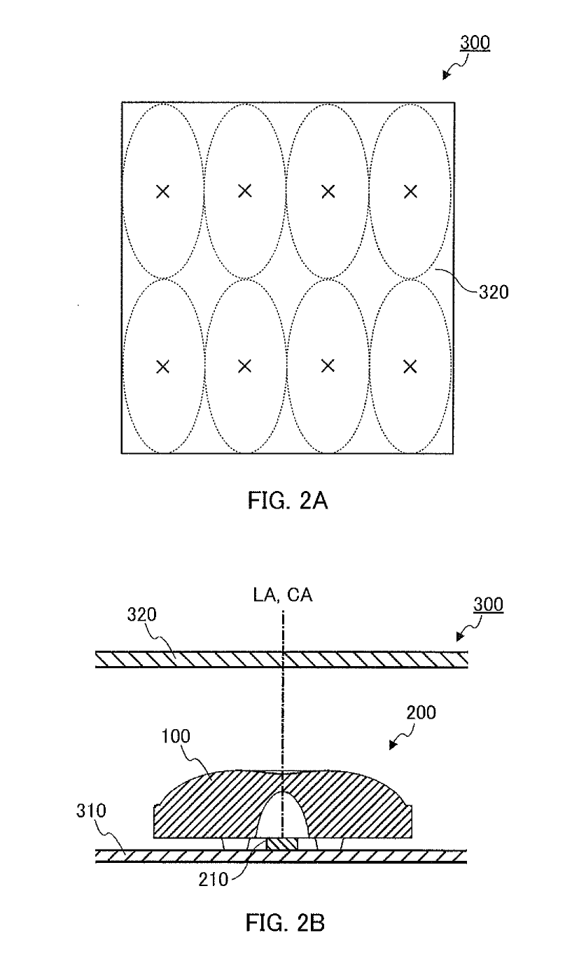

FIG. 2 is a diagram showing configurations of surface light source apparatus 300 and light emitting apparatus 200 according to Embodiment 1. FIG. 2A is a plan view of surface light source apparatus 300 according to Embodiment 1, and shows the arrangement of light emitting apparatus 200 within surface light source apparatus 300. FIG. 2B is a partially enlarged cross-sectional view of surface light source apparatus 300 according to Embodiment 1. In FIG. 2A, the positions of plural light emitting apparatuses 200 are schematically shown as “x”, and a region illuminated by each light emitting apparatus 200 is schematically shown as a dashed line.

As shown in FIG. 2, surface light source apparatus 300 of the present invention includes substrate 310, plural light emitting apparatuses 200 and light diffusion member 320. Plural light emitting apparatuses 200 are disposed on substrate 310 in a predetermined array and at predetermined intervals. Each of plural light emitting apparatuses 200 includes light emitting element 210 and light flux controlling member 100 (see FIG. 2B).

Light emitting element 210 is a light source of surface light source apparatus 300 (and light emitting apparatus 200), and is fixed on substrate 310. Light emitting element 210 is a light emitting diode (LED), such as a white light emitting diode.

Light flux controlling member 100 is an expanding lens that controls light distribution of light emitted from light emitting element 210. Light flux controlling member 100 is disposed on light emitting element 210 so that central axis CA thereof is consistent with optical axis LA of light emitting element 210 (see FIG. 2B). Meanwhile, both emission surface 110 and incidence surface 120 of light flux controlling member 100 to be described below have two-fold symmetry, and rotation axes thereof are consistent with each other. The rotation axes of emission surface 110 and incidence surface 120 are referred to as “central axis CA of light flux controlling member”. In addition, “optical axis LA of light emitting element” refers to a central light beam of a stereoscopic emission light flux from light emitting element 210. A gap for causing heat radiated from emitting element 210 to escape to the outside is formed between substrate 310 on which light emitting element 210 is mounted and back surface 130 of light flux controlling member 100 (see FIG. 2B).

Light flux controlling member 100 is formed by integral molding. The material of light flux controlling member 100 is not specifically limited as long as it is a material that can transmit light of a desired wave length. For example, the material of light flux controlling member 100 is a light-transmissive resin including polymethylmethacrylate (PMMA), polycarbonate (PC), and epoxy resin (EP), or is glass.

Surface light source apparatus 300 of the present invention has a principal characteristic in the configuration of light flux controlling member 100. Consequently, light flux controlling member 100 will be explained in detail separately.

Light diffusion member 320 is a plate-like member having light diffusion properties and transmits emission light from light flux controlling member 100 while diffusing the light. Normally, light diffusion member 320 has substantially the same size as an illumination target member such as a liquid crystal panel. For example, light diffusion member 320 is formed of a light-transmissive resin including polymethylmethacrylate (PMMA), polycarbonate (PC), polystyrene (PS), styrene-methyl methacrylate copolymer resin (MS). In order to impart light diffusion properties, fine irregularities are formed in the surface of light diffusion member 320, or light diffusion elements such as beads are dispersed inside light diffusion member 320.

In surface light source apparatus 300 of the present invention, light emitted from each light emitting element 210 is expanded by light flux controlling member 100 so as to illuminate a wide range of light diffusion member 320. At this time, light distribution of the light emitted from light emitting element 210 is controlled individually in two directions (in the example of FIG. 2A, a vertical direction and a horizontal direction) that are perpendicular to optical axis LA of light emitting element 210 and are perpendicular to each other (see FIG. 2A). The light emitted from each light flux controlling member 100 is further diffused by light diffusion member 320. As a result, surface light source apparatus 300 of the present invention can uniformly illuminate the plane-like illumination target member (for example, liquid crystal panel), compared with a surface light source apparatus of the related art.

Configuration of Light Flux Controlling Member

Next, the configuration of light flux controlling member 100 of the present embodiment will be described.

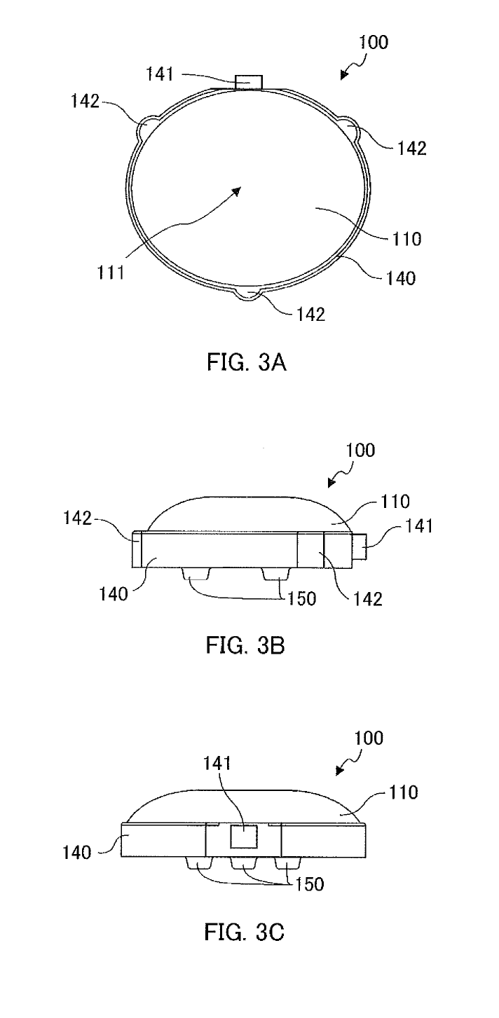

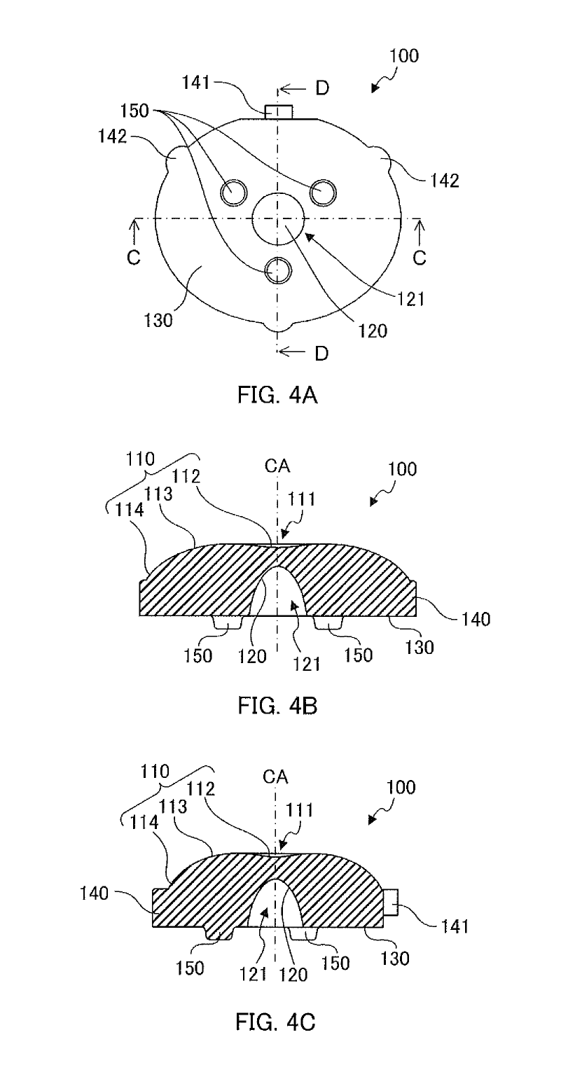

FIG. 3 and FIG. 4 are diagrams showing the configuration of light flux controlling member 100 according to Embodiment 1. FIG. 3A is a plan view of light flux controlling member 100, FIG. 3B is a right side view of light flux controlling member 100, and FIG. 3C is a rear view of light flux controlling member 100. FIG. 4A is a bottom view of light flux controlling member 100, FIG. 4B is a cross-sectional view taken along line C-C shown in FIG. 4A, and FIG. 4C is a cross-sectional view taken along line D-D shown in FIG. 4A.

As shown in FIG. 3 and FIG. 4, light flux controlling member 100 includes emission surface 110, incidence surface 120, back surface 130, flange 140, and plural leg portions 150.

Emission surface 110 emits light incident on the inside of light flux controlling member 100 to the outside while controlling the light distribution of the light. Emission surface 110 protrudes further upward (light diffusion member 320 side) than flange 140 (see FIG. 3B and FIG. 3C), and includes emission concave portion 111 formed so as to intersect with optical axis LA of light emitting element 210 (see FIG. 4B and FIG. 4C). In addition, an outer edge of emission surface 110 has an elliptical shape, and the shape of emission surface 110 have two-fold symmetry around central axis CA (see FIG. 3A).

Emission surface 110 includes first emission surface 112 that is located around central axis CA, second emission surface 113 that is formed continuously around first emission surface 112, and third emission surface 114 that connects second emission surface 113 and flange 140 to each other (see FIG. 4B and FIG. 4C). First emission surface 112 is an inner surface of emission concave portion 111 and is a level curved surface protruding downward (light emitting element 210 side). Second emission surface 113 is a level curved surface protruding upward (light diffusion member 320 side) which is located around first emission surface 112. Third emission surface 114 is a level curved surface located around second emission surface 113. In cross sections shown in FIG. 4B and FIG. 4C, the cross section of third emission surface 114 may have a straight line shape or a curved line shape.

All the cross sections of first emission surface 112, second emission surface 113, and third emission surface 114 which are perpendicular to central axis CA (optical axis LA of light emitting element 210) have an elliptical shape. That is, the cross-section of emission surface 110 which is perpendicular to central axis CA (optical axis LA of light emitting element 210) has an elliptical shape. In addition, an ellipse constituted by the cross sections of first emission surface 112, second emission surface 113, and third emission surface 114 which are perpendicular to central axis CA (optical axis LA of light emitting element 210), and an ellipse constituted by the outer edge of emission surface 110 are similar to each other. At this time, a long axis of the cross section (ellipse) of first emission surface 112, second emission surface 113, and third emission surface 114 and a long axis of the outer edge (ellipse) of emission surface 110 are parallel to each other.

Incidence surface 120 is an inner surface of incidence concave portion 121 that is formed on the opposite side of emission concave portion 111. Incidence surface 120 causes the majority of light (light (main light beam) emitted within a predetermined angle range with respect to optical axis LA of light emitting element 210) emitted from light emitting element 210 to be incident on the inside of light flux controlling member 100. Incidence concave portion 121 is formed in a central portion on the lower side (light emitting element 210 side) of light flux controlling member 100. Incidence surface 120 is a rotationally symmetric surface around central axis CA.

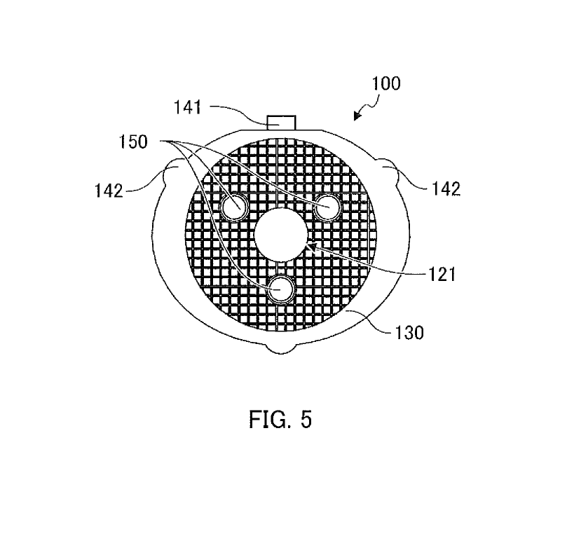

Back surface 130 is located on the opposite side of emission surface 110 and is a plane extending in a direction perpendicular to central axis CA (optical axis LA of light emitting element 210) from an opening edge portion of incidence concave portion 121. Back surface 130 is located so as to be separated from substrate 310 and causes light (sub-light beam) other than the main light beam of the light emitted from light emitting element 210 to be incident on the inside of light flux controlling member 100. Meanwhile, as shown in a bottom view of FIG. 5, a roughening process may be performed on back surface 130. In this manner, it is possible to prevent the light incident from back surface 130 from being concentrated in a particular direction. In addition, if it is not necessary to consider the radiation of heat from light emitting element 210, light flux controlling member 100 may be disposed such that back surface 130 comes into contact with substrate 310.

Flange 140 is located between an outer peripheral portion of emission surface 110 and an outer peripheral portion of back surface 130, and protrudes in a direction perpendicular to central axis CA (optical axis LA of light emitting element 210). Flange 140 is not essential, but the handling and positioning of light flux controlling member 100 are facilitated by providing flange 140. The thickness of flange 140 is not particularly limited, and is determined in consideration of a necessary area of emission surface 110, the moldability of flange 140, and the like. When light flux controlling member 100 is manufactured by injection molding, a gate mark 141 may be formed in flange 140. In addition, plural protruding portions 142 for causing an apparatus for manufacturing surface light source apparatus 300 to recognize the direction of light flux controlling member 100 may be formed in flange 140.

Plural leg portions 150 are column-shaped members protruding downward (light emitting element 210 side) from back surface 130, around incidence concave portion 121. Plural leg portions 150 perform a function that positions light flux controlling member 100 at an appropriate location with respect to light emitting element 210.

### Modified Example

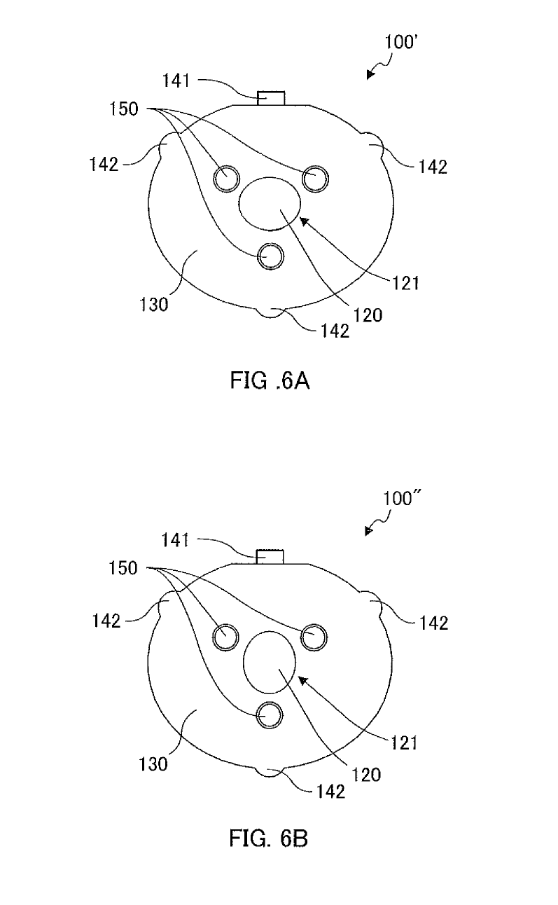

Meanwhile, incidence surface 120 may not be a rotationally symmetric surface around central axis CA. For example, as shown in bottom views of FIG. 6A and FIG. 6B, incidence concave portion 121 may be formed such that an opening of incidence concave portion 121 and the cross section of incidence concave portion which is perpendicular to central axis CA (optical axis LA of light emitting element 210) have an elliptical shape. That is, both the cross section of emission surface 110 and the cross section of incidence surface 120 may have an elliptical shape. At this time, a long axis of the cross section (ellipse) of emission surface 110 and a long axis of the cross section (ellipse) of incidence surface 120 may be parallel to each other (see FIG. 6A). In addition, the long axis of the cross section (ellipse) of emission surface 110 and a short axis of the cross section (ellipse) of incidence surface 120 may be parallel to each other (see FIG. 6B).

Effects

Light flux controlling member 100 of the present embodiment is formed such that at least the cross section of emission surface 110 which is perpendicular to central axis CA (optical axis LA of light emitting element 210) has an elliptical shape. For this reason, light flux controlling member 100 can control light distribution individually in two directions (x-axis direction and y-axis direction) that are perpendicular to optical axis LA of light emitting element 210 and are perpendicular to each other. In addition, in light flux controlling member 100 of the present embodiment, emission concave portion 111 is formed in a central portion of emission surface 110, and thus it is possible to diffuse light, which is emitted from light emitting element 210 reaching emission concave portion 111 (first emission surface 112) within a small angle range with respect to optical axis LA, in all directions perpendicular to optical axis LA. Therefore, light emitting apparatus 200 of the present embodiment which includes light flux controlling member 100 can illuminate a region having an elliptical shape of an arbitrary ellipticity with light. Even when light emitting apparatuses 200 are not disposed at equal intervals (in a square lattice shape), surface light source apparatus 300 of the present embodiment can suppress brightness unevenness.

### Embodiment 2

A surface light source apparatus and a light emitting apparatus according to Embodiment 2 of the present invention are different from surface light source apparatus 300 and light emitting apparatus 200 according to Embodiment 1 in that light flux controlling member 400 according to Embodiment 2 is provided instead of light flux controlling member 100 according to Embodiment 1. Consequently, in the present embodiment, only light flux controlling member 400 according to Embodiment 2 will be described. Meanwhile, in light flux controlling member 400 according to Embodiment 2, the shapes of emission surface 410 and incidence surface 420 are primarily different from that of light flux controlling member 100 according to Embodiment 1. Consequently, the same components as light flux controlling member 100 according to Embodiment 1 are denoted by the same reference numerals, and the description thereof will not be repeated.

Configuration of Light Flux Controlling Member

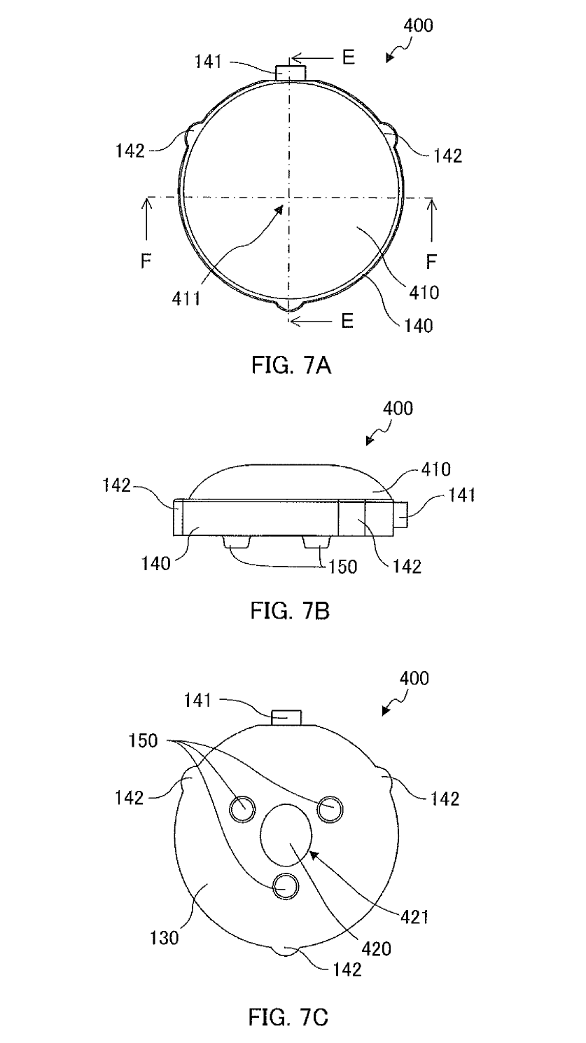

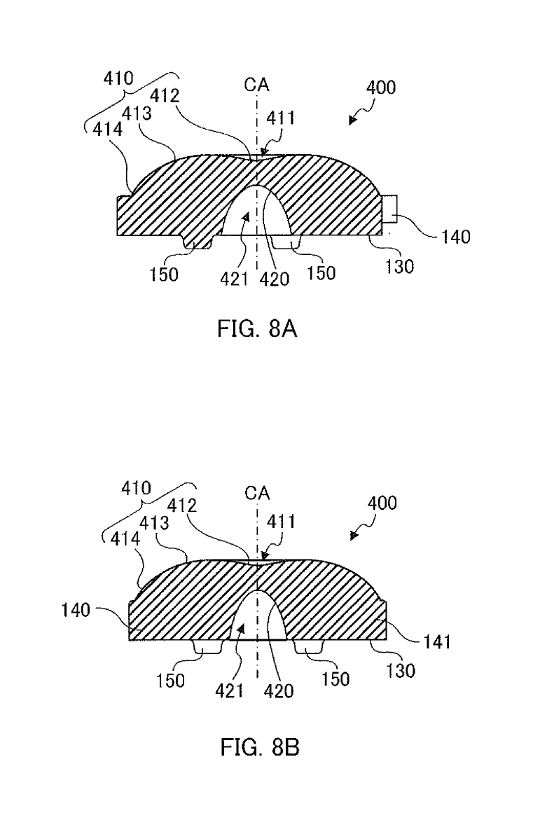

FIG. 7 and FIG. 8 are diagrams showing a configuration of light flux controlling member 400 according to Embodiment 2. FIG. 7A is a plan view of light flux controlling member 400, FIG. 7B is a right side view of light flux controlling member 400, FIG. 7C is a bottom view of light flux controlling member 400, FIG. 8A is a cross-sectional view taken along line E-E shown in FIG. 7A, and FIG. 8B is a cross-sectional view taken along line F-F shown in FIG. 7A.

As shown in FIG. 7 and FIG. 8, light flux controlling member 400 includes emission surface 410, incidence surface 420, back surface 130, flange 140, and plural leg portions 150.

Emission surface 410 emits light incident on the inside of light flux controlling member 400 to the outside while controlling the light distribution of the light. Emission surface 410 protrudes further upward (light diffusion member 320 side) than flange 140 (see FIG. 7B), and includes emission concave portion 411 that is formed so as to intersect with optical axis LA of light emitting element 210 (see FIG. 8A and FIG. 8B). Emission surface 410 has rotational symmetry (circular symmetry) around central axis CA (see FIG. 7A).

Emission surface 410 includes first emission surface 412 that is located around central axis CA, second emission surface 413 that is continuously formed around first emission surface 412, and third emission surface 414 that connects second emission surface 413 and flange 140 to each other (see FIG. 8A and FIG. 8B). First emission surface 412 is an inner surface of emission concave portion 411, and is a level curved surface protruding downward (light emitting element 210 side). First emission surface 412 has a concave shape in which a part of spherical surface is cut off. Second emission surface 413 is a level curved surface protruding upward (light diffusion member 320 side) which is located around first emission surface 412. Third emission surface 414 is a level curved surface located around second emission surface 413. In cross sections shown in FIG. 8A and FIG. 8B, the cross section of third emission surface 114 may have a straight line shape or a curved line shape.

As described above, in light flux controlling member 400 of the present embodiment, emission surface 410 has rotational symmetry (circular symmetry) around central axis CA. Therefore, all the cross sections of first emission surface 412, second emission surface 413, and third emission surface 414 which are perpendicular to central axis CA (optical axis LA of light emitting element 210) have a circular shape.

Incidence surface 420 is an inner surface of incidence concave portion 421 formed on the opposite side of emission concave portion 411. Incidence surface 420 causes the majority of light (light (main light beam) emitted within a predetermined angle range with respect to optical axis LA of light emitting element 210) emitted from light emitting element 210 to be incident on the inside of light flux controlling member 400. Incidence concave portion 421 is formed in a central portion on the lower side (light emitting element 210 side) of light flux controlling member 400.

In light flux controlling member 400 of the present embodiment, incidence concave portion 421 is formed such that an opening of incidence concave portion 421 and the cross section of the incidence concave portion which is perpendicular to central axis CA (optical axis LA of light emitting element 210) have an elliptical shape (see FIG. 7C). That is, in light flux controlling member 400 of the present invention, the cross section of emission surface 410 has a circular shape, but the cross section of incidence surface 420 has an elliptical shape.

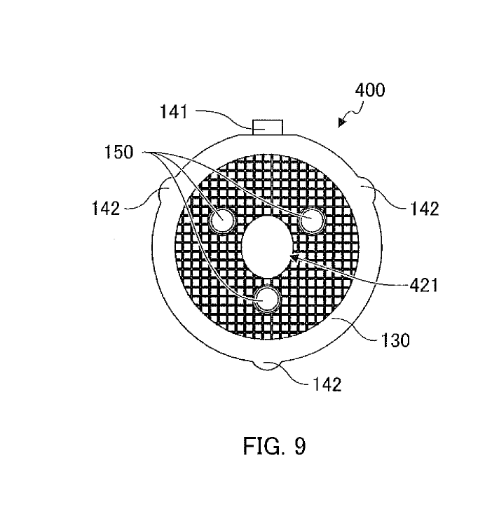

Meanwhile, as shown in a bottom view of FIG. 9, even in light flux controlling member 400 according to Embodiment 2, a roughening process may be performed on back surface 130.

Effects

Light flux controlling member 400 of the present embodiment has similar effects to light flux controlling member 100 according to Embodiment 1.

Simulation of Light Distribution Characteristic of Light Flux Controlling Member

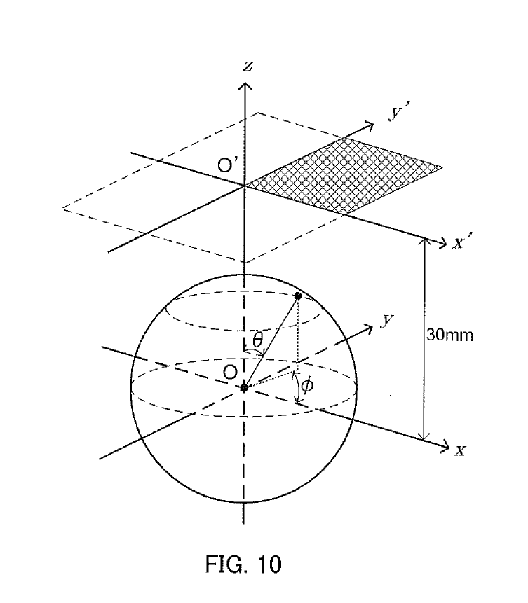

A simulation was performed with regard to light distribution characteristics of the light flux controlling member of the present invention. FIG. 10 is a diagram illustrating simulation conditions.

As shown in FIG. 10, it was assumed that a light beam is emitted at an angle (θ, φ) from original point O. The angle θ is an angle of the light beam with respect to a z-axis (θ=15°, 30°, 45°, 60°). In addition, an angle φ is an angle of the light beam with respect to an x-axis in a first quadrant of an xy plane (φ=0°, 15°, 30°, 45°, 60°, 75°, 90°). It was assumed that the light flux controlling member is disposed on the xy plane such that central axis CA thereof is consistent with the z-axis. A maximum outer diameter of the emission surface of the light flux controlling member is 17.7 mm, a maximum outer diameter of the incidence surface is 4.2 mm, and a maximum height (a height from the back surface of the light flux controlling member) is 4.5 mm. In addition, it was assumed that a plane (x′y′ plane) parallel to the xy plane which is located so as to be separated by 30 mm from the xy plane in a z-axis direction is a surface to be irradiated. In the simulation, it was examined which position of the surface to be irradiated had the light beam reached when the change was made to angle φ at a specific angle θ.

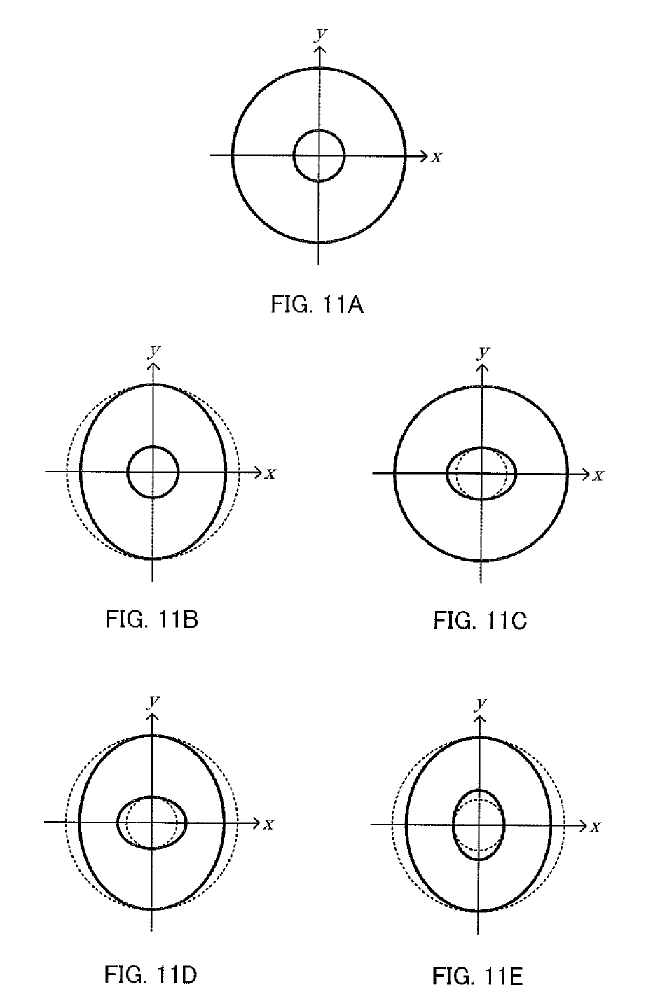

FIG. 11 are schematic plan views of five types of light flux controlling members used for the simulation. In each of the drawings, outer edges of the emission surface and the incidence surface are shown as a solid line. In addition, a circle that indicates the outer edges of the emission surface and the incidence surface is shown as a dashed line. In the following description, the cross section of the emission surface or the incidence surface which is perpendicular to the central axis is briefly referred to as “horizontal cross section”.

The light flux controlling member shown in FIG. 11A is a light flux controlling member according to a comparative example in which the outer edges and the horizontal cross sections of the emission surface and the incidence surface have a circular shape. The light flux controlling member shown in FIG. 11B is a light flux controlling member of the present invention in which the outer edge and the horizontal cross section of the emission surface have an elliptical shape, but the outer edge and the horizontal cross section of the incidence surface have a circular shape. The light flux controlling member shown in FIG. 11C is a light flux controlling member of the present invention in which the outer edge and the horizontal cross section of the incidence surface have a circular shape, but the outer edge and the horizontal cross section of the emission surface have an elliptical shape. The light flux controlling member shown in FIG. 11D is a light flux controlling member of the present invention in which both the outer edges and the horizontal cross sections of the emission surface and the incidence surface have an elliptical shape, and a long axis of the cross section of the emission surface and a short axis of the cross section of the incidence surface are parallel to each other. The light flux controlling member shown in FIG. 11E is a light flux controlling member of the present invention in which both the outer edges and the horizontal cross sections of the emission surface and the incidence surface have an elliptical shape, and a long axis of the cross section of the emission surface and a long axis of the cross section of the incidence surface are parallel to each other.

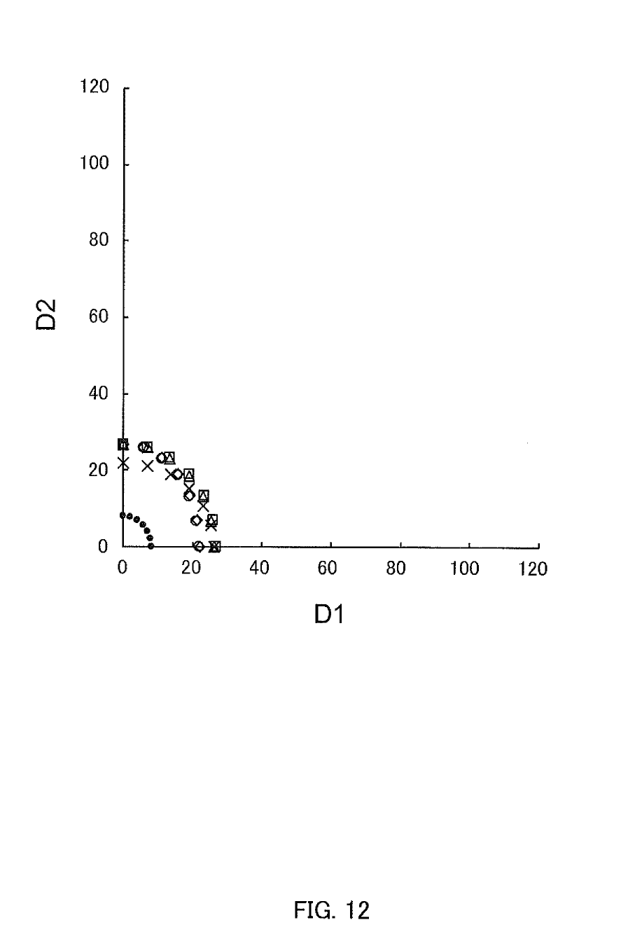

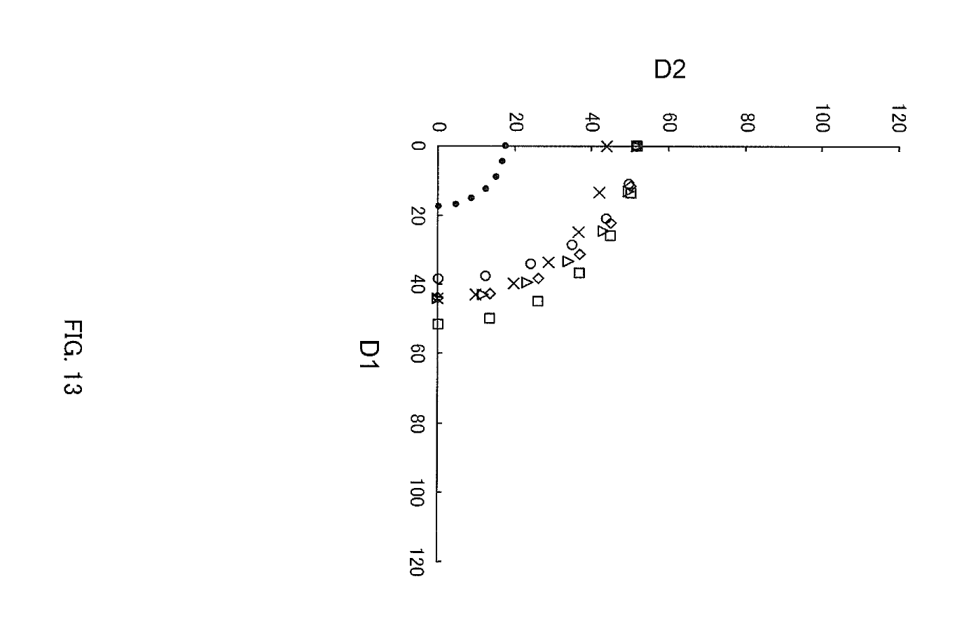

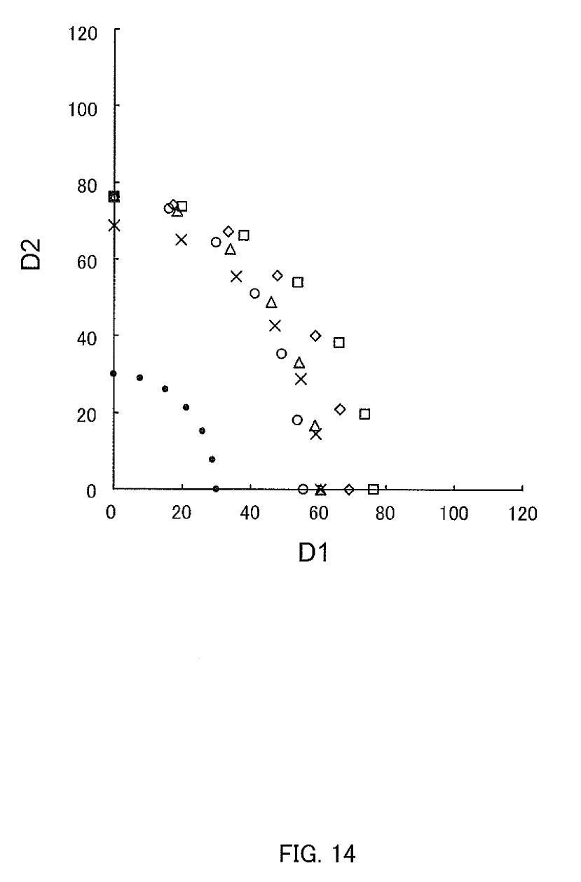

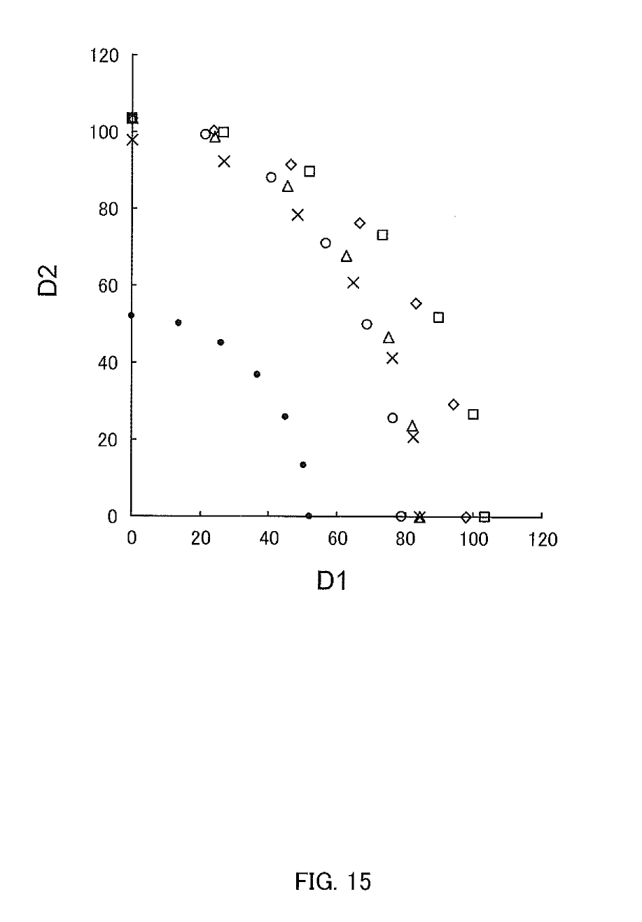

FIG. 12 to FIG. 15 are graphs showing simulation results. The graphs show an arrival position of each light beam (φ=0°, 15°, 30°, 45°, 60°, 75°, 90°) in a surface to be irradiated (x′y′ plane shown in FIG. 10). FIG. 12 shows simulation results when θ=15°. FIG. 13 shows simulation results when θ=30°. FIG. 14 shows simulation results when θ=45°. FIG. 15 shows simulation results when θ=60°. A horizontal axis of each graph represents a distance D1 from O′ in an x′-axis direction. A vertical axis represents a distance D2 from O′ in a y′-axis direction. As shown in FIG. 10, O′ is an intersection point between the surface to be irradiated (x′y′ plane) and a z-axis. In addition, in each graph, a circular symbol painted in black represents an arrival position of a light beam in a case where the light flux controlling member is not used. A white square symbol represents an arrival position of a light beam in a case where the light flux controlling member shown in FIG. 11A is used. A white triangular symbol represents an arrival position of a light beam in a case where the light flux controlling member shown in FIG. 11B is used. A white diamond-shaped symbol represents an arrival position of a light beam in a case where the light flux controlling member shown in FIG. 11C is used. A white circular symbol represents an arrival position of a light beam in a case where the light flux controlling member shown in FIG. 11D is used. An X-shaped symbol represents an arrival position of a light beam in a case where the light flux controlling member shown in FIG. 11E is used.

From FIG. 12 to FIG. 15, it is known that when the light flux controlling member is not used, light emitted from original point O reaches only a narrow region of the surface to be irradiated. In addition, when the light flux controlling member (FIG. 11A) according to the comparative example is used, it is known that the same degree of light is diffused in the x-axis direction and the y-axis direction. Meanwhile, when the light flux controlling members (FIGS. 11B to 11E) of the present invention are used, it is known that the degree of diffusion of light in the x-axis direction is different from the degree of diffusion of light in the y-axis direction.

In addition, when the light emitting element is an LED, the light distribution characteristics of emission light vary according to the arrangement of a semiconductor chip within the light emitting element, the shape of an encapsulation resin, and the like. It is possible to adjust the arrangement (a direction of an elliptical shape of an emission surface or an incidence surface in a horizontal cross section) of the light flux controlling member of the present invention in accordance with the light distribution characteristics of the light emitting element, and to obtain an intended region to be irradiated.

### INDUSTRIAL APPLICABILITY

The light flux controlling member, the light emitting apparatus, and the surface light source apparatus of the present invention, for example, can be applied to the backlight of the liquid crystal display apparatus and general lighting, etc.

### REFERENCE SIGNS LIST

100, 400 Light flux controlling member
110, 410 Emission surface
111, 411 Emission concave portion
112, 412 First emission surface
113, 413 Second emission surface
114, 414 Third emission surface
120, 420 Incidence surface
121, 421 Incidence concave portion
130 Back surface
140 Flange
141 Gate mark
142 Protruding portion
150 Leg portion
200 Light emitting apparatus
210 Light emitting element
300 Surface light source apparatus
310 Substrate
320 Light diffusion member
LA Optical axis of light emitting element
CA Central axis of light flux controlling member

1. A light flux controlling member for controlling a light distribution of light emitted from a light emitting element, the light flux controlling member comprising:
an emission surface that includes an emission concave portion formed so as to intersect with an optical axis of the light emitting element;
an incidence surface that constitutes an inner surface of an incidence concave portion formed on the opposite side of the emission concave portion; and
a back surface that extends in a direction perpendicular to the optical axis from an opening edge portion of the incidence concave portion,
wherein at least one of the emission surface and the incidence surface has an elliptical shape in cross section, the cross section being perpendicular to the optical axis.

2. The light flux controlling member according to claim 1, wherein both the emission surface and the incidence surface have an elliptical shape in cross section.

3. The light flux controlling member according to claim 2, wherein a long axis of the cross section of the emission surface and a long axis of the cross section of the incidence surface are parallel to each other.

4. The light flux controlling member according to claim 2, wherein a long axis of the cross section of the emission surface and a short axis of the cross section of the incidence surface are parallel to each other.

5. A light emitting apparatus comprising:
a light emitting element; and
the light flux controlling member according to claim 1.

6. A light emitting apparatus comprising:
a light emitting element; and
the light flux controlling member according to claim 2.

7. A light emitting apparatus comprising:
a light emitting element; and
the light flux controlling member according to claim 3.

8. A light emitting apparatus comprising:
a light emitting element; and
the light flux controlling member according to claim 4.

9. A surface light source apparatus comprising:
the light emitting apparatus according to claim 5; and
a light diffusion member for transmitting light emitted from the light emitting apparatus while diffusing the light.

10. A surface light source apparatus comprising:
the light emitting apparatus according to claim 6; and
a light diffusion member for transmitting light emitted from the light emitting apparatus while diffusing the light.

11. A surface light source apparatus comprising:
the light emitting apparatus according to claim 7; and
a light diffusion member for transmitting light emitted from the light emitting apparatus while diffusing the light.

12. A surface light source apparatus comprising:
the light emitting apparatus according to claim 8; and
a light diffusion member for transmitting light emitted from the light emitting apparatus while diffusing the light.

13. A display apparatus comprising:
the surface light source apparatus according to claim 9; and
a display member to be irradiated with light emitted from the surface light source apparatus.

14. A display apparatus comprising:
the surface light source apparatus according to claim 10; and
a display member to be irradiated with light emitted from the surface light source apparatus.

15. A display apparatus comprising:
the surface light source apparatus according to claim 11; and
a display member to be irradiated with light emitted from the surface light source apparatus.

16. A display apparatus comprising:
the surface light source apparatus according to claim 12; and
a display member to be irradiated with light emitted from the surface light source apparatus.
